(19) United States
(12) Patent Application Publication
(10) Pub. No.: US 2008/0047617 A1
(43) Pub. Date: Feb. 28, 2008

(54) Hydraulic control apparatus

(75) Inventor: Akinori Hirano, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/889,758

(22) Filed: Aug. 16, 2007

(30) Foreign Application Priority Data
Aug. 28, 2006 (JP) 2006-230498
Aug. 7, 2007 (JP) 2007-205100

(51) Int. Cl. F15B 13/044

(52) U.S. Cl. 137/487.5

(57) ABSTRACT

A hydraulic control apparatus includes a valve case, a spool, a control orifice, and a pilot valve. The valve case includes a hydraulic fluid input port, a hydraulic fluid output port, a pilot fluid supply port, and a pilot fluid discharge port, and the valve case internally has a pilot fluid supply chamber and a pressure control chamber communicated with the supply port and with the discharge port. The pilot valve is connected to the discharge port to allow and prohibit discharge of pilot fluid through the discharge port. The spool prohibits communication between the supply chamber and the pressure control chamber when the spool is actuated in accordance with a drop in pressure of pilot fluid in the pressure control chamber. The spool allows the communication when the spool is actuated in accordance with a rise in pressure of pilot fluid in the pressure control chamber.

### CROSS REFERENCE TO RELATED APPLICATION

This application is based on and incorporates herein by reference Japanese Patent Application No.2006-230498 filed on Aug. 28, 2006 and Japanese Patent Application No. 2007-205100 filed on Aug. 7, 2007.

### BACKGROUND OF THE INVENTION

1. Field of the Invention

The present invention relates to a hydraulic control apparatus provided with an amplifier valve and a pilot valve.

2. Description of Related Art

JP-A-2001-521662 (corresponding to U.S. Pat. No. 6,418,964) and JP-A-2002-357281 (corresponding to U.S. Pat. No. 6,615,869) disclose a conventional hydraulic control apparatus provided with a valve case and a spool. The valve case includes a hydraulic fluid input port and a hydraulic fluid output port. The spool allows and prohibits communication between the hydraulic fluid input port and the hydraulic fluid output port. Also, the spool is actuated by pilot fluid. In the hydraulic control apparatus, when supply of pilot fluid is unnecessary, circulation of pilot fluid is limited such that the consumption flow amount of pilot fluid is controlled.

In the hydraulic control apparatus disclosed in JP-A-2001-521662, a ball and a valve seat are installed in a flow passage of pilot fluid for limiting circulation of pilot fluid when pilot fluid is unnecessary. Thus, opening and closing of the flow passage (circulation passage) of pilot fluid are changed by engaging and disengaging of the ball with the valve seat. However, with this structure, in a state, where the ball is engaged with the valve seat, even if supply of the pilot fluid is started, the supply flow rate (flow amount) of the pilot fluid may be disadvantageously restricted in the gap between the ball and the valve seat until the ball is completely disengaged from the valve seat. Therefore, the response of the spool actuation to the speed of supply of the pilot fluid may deteriorate in the meantime. When the viscosity of the pilot fluid becomes high especially due to a low temperature, this disadvantage occurs apparently.

In order to solve the above disadvantage in the above response, the hydraulic control apparatus disclosed in JP-A-2002-357281 employs the following structure for limiting the circulation of the pilot fluid when supply of the pilot fluid is unnecessary. That is, when the spool is actuated in accordance with a drop in pressure of the pilot fluid in a pressure control chamber, the flow passage of the pilot fluid is blockaded (closed) by the end surface of the spool. Also, when the spool is actuated in accordance with an increase (rise) in pressure of the pilot fluid, the end surface of the spool will open the flow passage of the pilot fluid. In a state, where the spool end surface closes the flow passage of the pilot fluid in this structure, when the supply of the pilot fluid is selectively allowed and prohibited, the spool is actuated immediately. Therefore, deterioration of the response of the spool actuation to the supply of the pilot fluid is avoidable.

For example, the hydraulic control apparatus disclosed in JP-A-2002-357281 includes an amplifier valve and a pilot valve as a unit. Typically, the amplifier valve includes a valve case and a spool. Also, the pilot valve allows and prohibits the supply of the pilot fluid. And the above control structure is applied to the unit-type hydraulic control apparatus as above. Here, the above control structure typically opens and closes the flow passage of the pilot fluid by the end surface of the spool. However, it is difficult by the following reason to directly apply the above structure to the hydraulic control apparatus (see FIGS. 3 and 4), in which an amplifier valve 10 and a pilot valve 20 are constituted separately.

That is, in the hydraulic control apparatus of the separated structure, a pressure control chamber 141a, which adjoins an end surface 121 of a spool 12 as shown in FIGS. 3, 4 of related art, is located on an end of the flow passage of the pilot fluid. Therefore, the above disclosed structure for opening and closing the flow passage of the pilot fluid by the end surface of the spool 12 is not directly applied.

Here, FIG. 3 shows a state, where a coil 26 is deenergized such that a pilot valve 20 is actuated to prohibit the supply of the pilot fluid. An opening of a seat portion 224 is opened by a moving core 21 in this state. Also, the pilot fluid passes through a control orifice 145a (restrictor) provided in the pilot valve 20. Therefore, the pilot fluid flows from a drain port 222 of the pilot valve 20 into a drain piping (not shown).

In contrast, FIG. 4 shows another state, where the coil 26 is energized such that the pilot valve 20 is actuated to supply the pilot fluid. The seat portion 224 is closed by the moving core 21 in this state. Also, the pilot fluid supplied to a pilot fluid supply port 225 passes through the control orifice 145a provided in the pilot valve 20. Therefore, the pilot fluid is supplied to a pilot fluid inlet port 118a formed in a valve case 11, and the pilot fluid flows into a pressure control chamber 141a. As a result, the spool 12 is actuated such that hydraulic fluid for a control pressure (e.g., clutch control pressure) is outputted from the amplifier valve 10.

### SUMMARY OF THE INVENTION

The present invention is made in view of the above disadvantages. Thus, it is an objective of the present invention to address at least one of the above disadvantages.

To achieve the objective of the present invention, there is provided a hydraulic control apparatus, which includes a valve case, a spool, a control orifice, and a pilot valve. The valve case includes a hydraulic fluid input port, a hydraulic fluid output port, a pilot fluid supply port, and a pilot fluid discharge port, and the valve case internally has a pilot fluid supply chamber and a pressure control chamber, which are in communication with the pilot fluid supply port and with the pilot fluid discharge port. The spool is actuated by pilot fluid flowing into the pressure control chamber to allow and prohibit communication between the hydraulic fluid input port and the hydraulic fluid output port. The control orifice is provided upstream of the pilot fluid supply chamber and of the pressure control chamber in a flow passage of pilot fluid, and the control orifice controls a flow amount of pilot fluid flowing into the pressure control chamber. The pilot valve is adapted separately from an amplifier valve having the valve case and the spool. The pilot valve is connected to the pilot fluid discharge port to allow and prohibit discharge of pilot fluid through the pilot fluid discharge port. The spool prohibits communication between the pilot fluid supply chamber and the pressure control chamber when the spool is actuated in accordance with a drop in pressure of pilot fluid in the pressure control chamber. The spool allows the communication between the pilot fluid supply chamber and the pressure control chamber when the spool is actuated in accordance with a rise in pressure of pilot fluid in the pressure control chamber.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view showing a hydraulic control apparatus according to one embodiment of the present invention, and showing a state, where the hydraulic control apparatus is actuated so that the output of clutch hydraulic fluid is stopped;

FIG. 2 is a schematic view of the hydraulic control apparatus shown in FIG. 1 showing a state, where the hydraulic control apparatus is actuated so that the clutch hydraulic fluid is outputted;

FIG. 3 is a schematic view showing a related hydraulic control apparatus, and showing a state, where a pilot valve is operated to prohibit an output of a pilot fluid; and

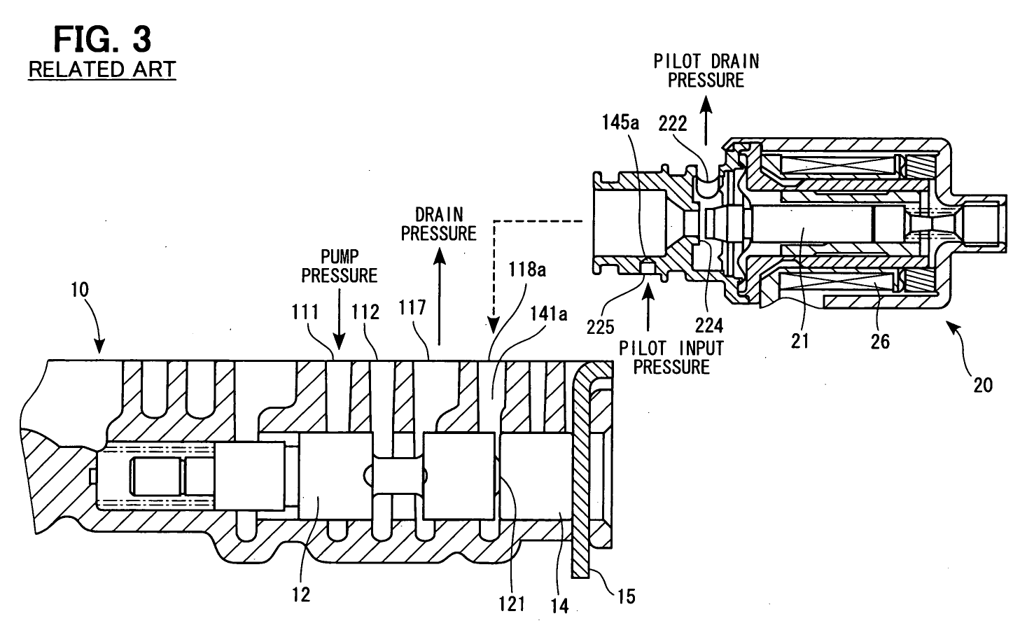

FIG. 4 is a schematic view of the related hydraulic control apparatus shown in FIG. 3 showing a state, where the pilot valve is operated to allow the output of the pilot fluid.

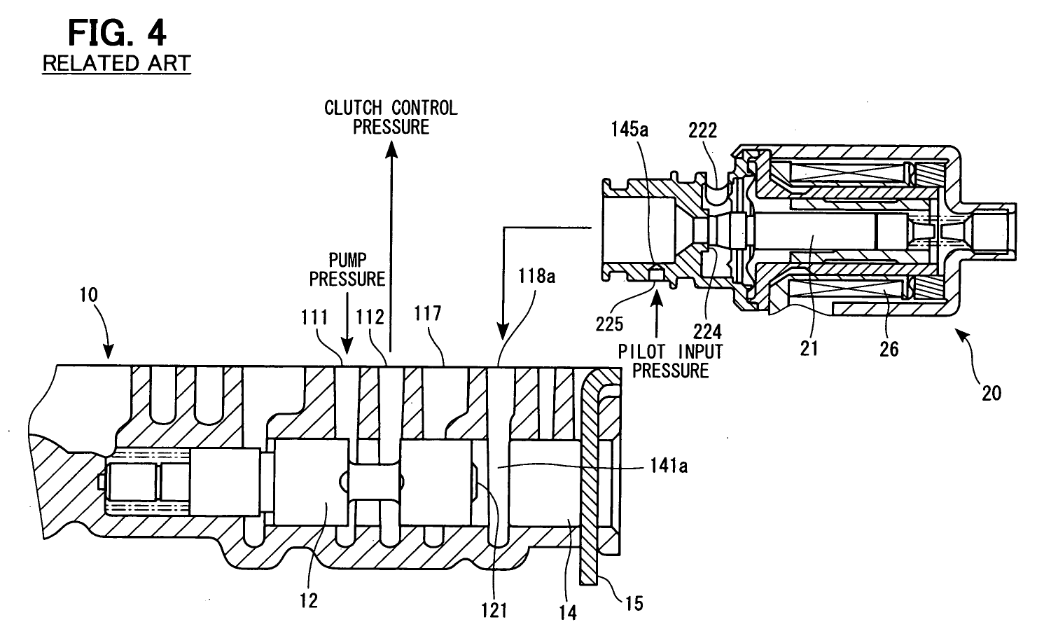

### DETAILED DESCRIPTION OF PREFERRED EMBODIMENTS

### Embodiment

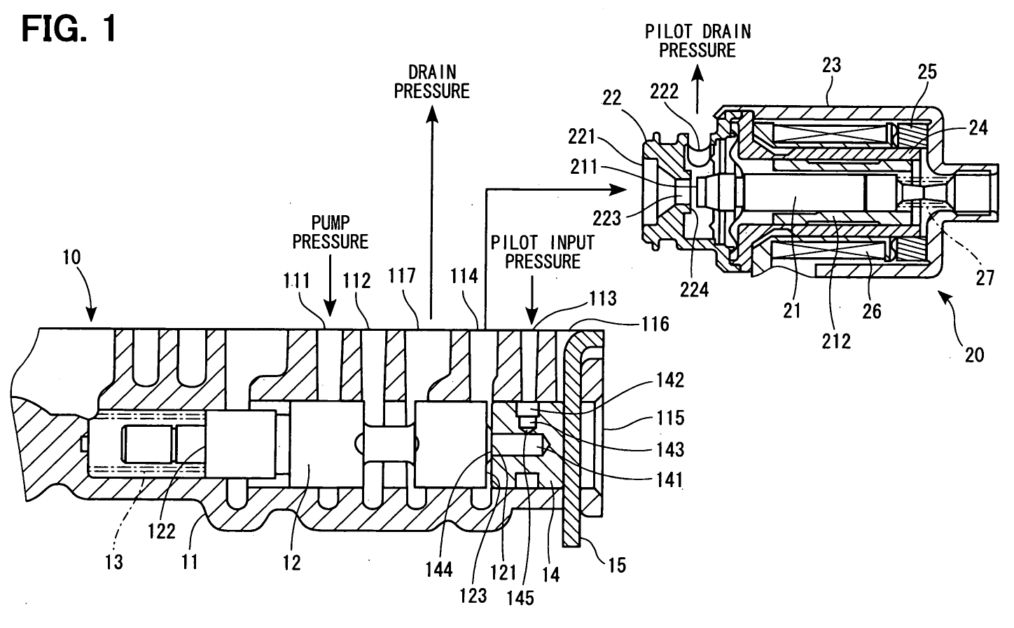

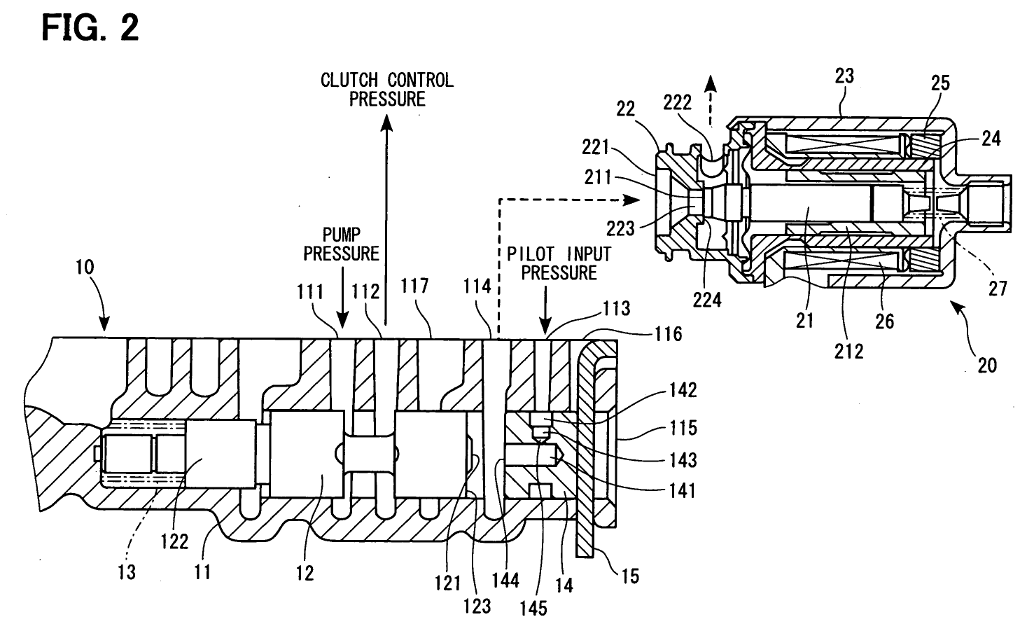

Hereafter, one embodiment of the present invention is described referring to FIGS. 1 and 2.

In the present embodiment, a hydraulic control apparatus of the present invention is applied to a hydraulic control apparatus, which controls an oil pressure of a clutch hydraulic fluid supplied to a friction element (a clutch or brake) mounted on an automatic transmission. FIG. 1 shows the hydraulic control apparatus of an operational state, where the output of the clutch hydraulic fluid to the friction element is stopped (prohibited) to release a friction element. FIG. 2 shows the hydraulic control apparatus of another operational state, where the clutch hydraulic fluid is outputted to the friction element to engage the friction element.

The hydraulic control apparatus of the present embodiment is provided with an amplifier valve 10 and a pilot valve 20. The amplifier valve 10 is a valve, which allows and prohibits supply of the clutch hydraulic fluid to the friction element, and is actuated in accordance with the pilot fluid supplied from the pilot valve 20. Typically, the amplifier valve 10 is connected to the pilot valve 20 through a piping, and the amplifier valve 10 is formed separately from the pilot valve 20.

A Structure of the amplifier valve 10 is described. The amplifier valve 10 includes a valve case 11, a spool 12, a coil spring 13 serving as a biasing member, a spacer 14, and a stopper 15.

The valve case 11 includes a hydraulic fluid input port 111, a hydraulic fluid output port 112, a hydraulic fluid drain port 117, a pilot fluid supply port 113, and a pilot fluid discharge port 114. Adjusted oil adjusted at a line pressure is inputted into the hydraulic fluid input port 111. Typically, the adjusted oil is discharged from a hydraulic pump (not shown) and its pressure is adjusted (regulated) by line pressure generating means to a predetermined pressure. Here, the hydraulic pump is rotated by a rotation driving force of an input shaft of the automatic transmission.

The oil of the line pressure is outputted through the hydraulic fluid output port 112, and the oil is supplied to the friction element as the clutch hydraulic fluid. The spool 12 is slidably provided in the valve case 11. When the spool 12 is displaced to a position shown in FIG. 2, the hydraulic fluid input port 111 and the hydraulic fluid output port 112 are communicated with each other, and the clutch hydraulic fluid is supplied to the friction element as above. In contrast, when the spool 12 is displaced to another position shown in FIG. 1, the communication between the hydraulic fluid input port 111 and the hydraulic fluid output port 112 is prohibited by the spool 12. At this time, the hydraulic fluid output port 112 and the hydraulic fluid drain port 117 are communicated with each other. In this way, the supply (output) of the clutch hydraulic fluid to the friction element is stopped (prohibited), and the oil in the friction element is discharged through the hydraulic fluid drain port 117 such that the friction element is disengaged.

The valve case 11 internally has a pilot fluid supply chamber 141 and a pressure control chamber, which are communicated with the pilot fluid supply port 113 and the pilot fluid discharge port 114. The spool 12 has an end surface 121 biased leftward of FIG. 1 (e.g., toward the other end of the spool 12 opposite the end surface 121) by the pressure of the pilot fluid in the pressure control chamber. Also, the spool 12 has the other end surface 122 biased by the coil spring 13 rightward of FIG. 1. Thus, when the biasing force by the pilot fluid becomes larger than the biasing force by the coil spring 13, the spool 12 slides leftward to be positioned at an actuated position shown in FIG. 2. When the biasing force by the pilot fluid becomes smaller than the biasing force by the coil spring 13, the spool 12 slides rightward to be positioned at an actuated position shown in FIG. 1.

A spacer 14 is arranged inside the valve case 11. When the spool 12 slides rightward of FIG. 1 in accordance with a drop in pressure of the pilot fluid in the pressure control chamber, the end surface 121 of the spool 12 contacts the spacer 14. Thereby, an actuation termination position (position shown in FIG. 1) of spool 12 is determined (for example, the spacer 14 defines a position, at which the spool 12 is stopped). The spacer 14 is supported in the sliding direction of the spool 12, in which the spool 12 slides, by the stopper 15 attached to the valve case 11.

Here, the assembly procedure of several kinds of parts, which constitute the amplifier valve 10, is explained briefly. The valve case 11 has an insertion bore 115 formed in the end of the valve case 11. Firstly, the coil spring 13, the spool 12, and the spacer 14 are inserted into the valve case 11 through the insertion bore 115 in order. Next, the stopper 15 is inserted through an insertion bore 116 formed in the side face of the valve case 11, and the assembly is completed.

The spacer 14 has an approximate circular column shape. The pilot fluid supply chamber 141 extended in the sliding direction (left-right direction of FIG. 1) of the spool 12 is formed inside of the spacer 14. An annular port 142 is formed in an outer peripheral face of the spacer 14. The port 142 is communicated with the pilot fluid supply chamber 141 through a communication passage 143 extended in a radial direction of the spacer 14.

The pilot fluid supply chamber 141 has an exit portion 144 that is opened and closed by the end surface 121 of the spool 12. That is, when the pressure in the pressure control chamber is dropped (decreased), the spool 12 slides to contact with the spacer 14. At this time, the end surface 121 of the spool 12 closes the exit portion 144 of the pilot fluid supply chamber 141. Thereby, the communication between the pilot fluid supply chamber 141 and the pressure control chamber is prohibited (disabled). In contrast, when the pilot valve 20 is operated to prohibit the outflow of the pilot fluid in order to increase the pressure in the pressure control chamber, the spool 12 slides to disengage from the spacer 14. Therefore, the communication between the pilot fluid supply chamber 141 and the pressure control chamber is allowed (enabled).

Therefore, the end surface 121 of the spool 12 is moved with the sliding of the spool 12 such that the end surface 121 allows and prohibits the outflow (discharge) of the pilot fluid through the pilot fluid discharge port 114.

It is noted that adjusted oil adjusted at a modulated pressure is inputted into the pilot fluid supply port 113. Typically, the adjusted oil is discharged from the hydraulic pump (above described) and its pressure is adjusted (regulated) by modulated pressure generating means to a predetermined pressure.

The spacer 14 has a control orifice 145. More specifically, the control orifice 145 is formed in a downstream end portion of the communication passage 143 (e.g., downstream in a flow direction of the pilot fluid). The control orifice 145 serves as a restrictor for controlling the flow amount of the pilot fluid, which is supplied through the pilot fluid supply port 113, and which flows into the pressure control chamber.

A structure of the pilot valve 20 is described below. The pilot valve 20 includes a moving core 21, a seat member 22, a yoke 23, a stator core 24, a magnetic ring 25, a coil 26, and a coil spring 27 serving as biasing means. The moving core 21 slides inside the pilot valve 20 by turning on/turning off the energization to the coil 26 (i.e., by energizing and deenergizing). Then, the moving core 21 selectively allows and prohibits outflow of the pilot fluid to the drain piping.

More specifically, the seat member 22 includes an intake port 221 and a drain port 222. Typically, the intake port 221 is connected with the pilot fluid discharge port 114 through a piping, which is not illustrated. The drain port 222 is connected to the drain piping, which is not illustrated. The seat member 22 includes a communication passage 223 therein, which provides communication between the intake port 221 and the drain port 222. Also, the communication passage 223 includes a seat portion 224, which is opened and closed by an end surface 211 of the moving core 21. Thereby, outflow (discharge) of the pilot fluid to the drain piping is selectively allowed and prohibited.

A magnetic circuit is formed by the yoke 23, the stator core 24, and the magnetic ring 25. When the coil 26 is energized, magnetic force occurs in the magnetic circuit, and a magnetic part 212 fixed to the moving core 21 is attracted by the magnetic force. Therefore, the moving core 21 is biased in the direction (leftward of FIG. 1) for closing the seat portion 224. Also, the coil spring 27 biases the moving core 21 in the direction for closing (blockading) the seat portion 224. In contrast, the moving core 21 receives force in the direction (rightward of FIG. 1) for displacing the moving core 21 away from the seat portion 224 due to the pressure of the pilot fluid, which flows into through the intake port 221.

Therefore, when the coil 26 is energized, a total force, which includes the biasing force by the coil spring 27 and the attractive force by the above magnetic force becomes larger than a force received from the pilot fluid. As a result, the moving core 21 moves in the direction for blockading the seat portion 224, and the seat portion 224 is blockaded. In contrast, when the energization to the coil 26 is stopped (e.g., the coil 26 is deenergized), the force received from the pilot fluid becomes larger than the total force, which includes the biasing force by the coil spring 27 and the attractive force by the magnetic force. As a result, the moving core 21 moves in the direction for displacing away from the seat portion 224, and the seat portion 224 is opened.

Next, the operation of the hydraulic control apparatus by the above structure is explained.

When the output of the clutch hydraulic fluid to the friction element in order to release the friction element as shown in FIG. 1, the energization to the coil 26 of the pilot valve 20 is stopped. Then, in the pilot valve 20, the seat portion 224 is opened with the movement of the moving core 21. At this time, the pilot fluid in the pressure control chamber flows out through the pilot fluid discharge port 114. And the pilot fluid flows into the drain piping through the intake port 221, the communication passage 223, and the drain port 222. Therefore, the pressure of the pilot fluid in the pressure control chamber drops (decreases).

As a result, the spool 12 slides rightward of FIG. 1 to contact the spacer 14 in the amplifier valve 10. Thereby, the communication between the pilot fluid supply chamber 141 and the pressure control chamber is prohibited. Therefore, the pilot fluid supplied to the pilot fluid supply port 113 is limited from being kept supplied into the drain piping. Therefore, the communication between the hydraulic fluid input port 111 and the hydraulic fluid output port 112 is prohibited. Therefore, the output of the clutch hydraulic fluid to the friction element is stopped (suspended).

In a state, where the end surface 121 of the spool 12 closes (blocks) the exit portion 144 of the pilot fluid supply chamber 141, the pilot fluid is still kept supplied to the pilot fluid supply chamber 141. However, the pressure in the pressure control chamber is limited from rising, because in the above state, it is designed that a bias force by the coil spring 13 is larger than a bias force generated correspondingly to a product of an area of the exit portion 144 multiplied by the pilot fluid supply pressure. Thus, the spool 12 is limited from sliding again leftward of FIG. 1. As a result, the pilot fluid, which flows into the pilot fluid supply chamber 141 through the control orifice 145, is leaked slightly through a gap between the end surface 121 of the spool 12 and the exit portions 144 of the pilot fluid supply chamber 141.

When the clutch hydraulic fluid is outputted to the friction element as shown in FIG. 2 in order to engage the clutch of the friction element, the coil 26 of the pilot valve 20 is energized. Then, in the pilot valve 20, the seat portion 224 is closed with the movement of the moving core 21. Then, the piping (not shown), which connects the pilot fluid discharge port 114 and the intake port 221, is filled with the pilot fluid leaked through the gap between the end surface 121 and the exit portion 144 as mentioned above. Thus, the pressure in the pilot fluid discharge port 114 (i.e., the pressure in the pressure control chamber) rises (increases) accordingly.

As a result, in amplifier valve 10, a peripheral portion 123 of the end surfaces 121 of the spool 12, which portion 123 is positioned apart from the exit portion 144 of the pilot fluid supply chamber 141, is biased by the increased pressure of the pilot fluid in the pilot fluid discharge port 114. Therefore, the spool 12 starts sliding leftward of FIG. 1. Thereby, the pilot fluid discharge port 114 and the pilot fluid supply chamber 141 are communicated with each other. Therefore, the increased pressure in the pressure control chamber due to the pilot fluid supplied to the pilot fluid supply port 113 slidably displaces the spool 12 to the position shown in FIG. 2. Accordingly, the spool 12 provides communication between the hydraulic fluid input port 111 and the hydraulic fluid output port 112, and the clutch hydraulic fluid is outputted to the friction element.

According to the above present embodiment, in the hydraulic control apparatus, in which the pilot valve 20 and the amplifier valve 10 are formed separately, the valve case 11 includes the pilot fluid discharge port 114 in communication with the pilot fluid supply chamber 141 and the pressure control chamber. Also, the pilot valve 20 is connected to the pilot fluid discharge port 114. Therefore, the pressure control chamber is located not in the end of the flow passage for the pilot fluid but in the middle of the flow passage (for example, the pilot fluid supply port 113 is disposed upstream of the pilot fluid supply chamber 141 for supplying pilot fluid into the pressure control chamber, and the pilot fluid discharge port 114 is disposed downstream of the pressure control chamber). Here, downstream and upstream are described based on a flow direction of pilot fluid, for example. Therefore, this realizes a structure, in which the communication between the pilot fluid discharge port 114, the pressure control chamber, and the pilot fluid supply chamber 141 can be closed by the end surface 121 of the spool 12.

Therefore, when the spool 12 is actuated so that the communication between the hydraulic fluid input port 111 and the hydraulic fluid output port 112 is prohibited, that is, when the supply of the pilot fluid to the pressure control chamber is unnecessary, the communication between the pilot fluid supply chamber 141 and the pressure control chamber is stopped by the end surface 121 of the spool 12. Therefore, this limits the pilot fluid from being circulated by the pilot valve 20. As a result, the consumption flow rate of the pilot fluid can be controlled.

Also, the end surface 121 of the spool 12 is adapted to selectively open and close the flow passage of the pilot fluid. Therefore, in a state, where the communication between the pilot fluid supply chamber 141 and the pressure control chamber is disabled, the spool 12 can be actuated (displaced) immediately after the pilot valve 20 is operated to limit the discharge of the pilot fluid through the pilot fluid discharge port 114 by energization of the coil 26. Therefore, deterioration of response of the spool actuation relative to the change of operation of the pilot valve 20 is limited.

The hydraulic control apparatus according to the present embodiment has the spacer 14, which contacts the spool 12 to determines the actuation termination position of the spool 12. Also, the spacer 14 has the pilot fluid supply chamber 141 therein. Therefore, the interior space of the valve case 11 can be used effectively.

### Other Embodiment

In the above embodiment shown in FIGS. 1 and 2, the control orifice 145 is formed in the spacer 14. However, the control orifice 145 of the present invention is not limited to such arrangement. For example, the control orifice 145 may be provided in a portion of the pilot fluid supply port 113 of the valve cases 11. Also, the control orifice 145 may be provided in the upstream portion of the pilot fluid supply port 113 in the flow passage, through which the pilot fluid is supplied.

Thus, the present invention is not limited to the above embodiment, and can be applied to various embodiments in the range which does not deviate from the gist.

Additional advantages and modifications will readily occur to those skilled in the art. The invention in its broader terms is therefore not limited to the specific details, representative apparatus, and illustrative examples shown and described.

What is claimed is:

1. A hydraulic control apparatus comprising:
a valve case that includes a hydraulic fluid input port, a hydraulic fluid output port, a pilot fluid supply port, and a pilot fluid discharge port, the valve case internally having a pilot fluid supply chamber and a pressure control chamber, which are in communication with the pilot fluid supply port and with the pilot fluid discharge port;
a spool that is actuated by pilot fluid flowing into the pressure control chamber to allow and prohibit communication between the hydraulic fluid input port and the hydraulic fluid output port;
a control orifice that is provided upstream of the pilot fluid supply chamber and of the pressure control chamber in a flow passage of pilot fluid, the control orifice controlling a flow amount of pilot fluid flowing into the pressure control chamber; and
a pilot valve that is adapted separately from an amplifier valve having the valve case and the spool, the pilot valve being connected to the pilot fluid discharge port to allow and prohibit discharge of pilot fluid through the pilot fluid discharge port, wherein:
the spool prohibits communication between the pilot fluid supply chamber and the pressure control chamber when the spool is actuated in accordance with a drop in pressure of pilot fluid in the pressure control chamber; and
the spool allows the communication between the pilot fluid supply chamber and the pressure control chamber when the spool is actuated in accordance with a rise in pressure of pilot fluid in the pressure control chamber.

2. The hydraulic control apparatus according to claim 1, the apparatus further comprising a spacer that contacts with the spool to define an actuation termination position of the spool when the spool is actuated in accordance with the drop in the pressure of pilot fluid in the pressure control chamber, wherein the spacer is disposed inside the valve case and internally includes the pilot fluid supply chamber.

3. The hydraulic control apparatus according to claim 2, wherein the actuation termination position is a position, at which the spool is stopped.

4. The hydraulic control apparatus according to claim 1, wherein:
the pilot fluid supply port is disposed upstream of the pilot fluid supply chamber and of the pressure control chamber for supplying pilot fluid into the pressure control chamber; and
the pilot fluid discharge port is disposed downstream of the pilot fluid supply chamber and of the pressure control chamber.
